(19) United States
(12) Patent Application Publication
(10) Pub. No.: US 2025/0356519 A1
(43) Pub. Date: Nov. 20, 2025

(54) SYSTEM AND METHOD FOR EVALUATING THE OPTICAL SYMMETRY OF LOOSE DIAMONDS

(71) Applicants: VICTOR CANERA, LOS ANGELES, CA (US); NATHANIEL ANTER CANERA, LOS ANGELES, CA (US)

(72) Inventors: VICTOR CANERA, LOS ANGELES, CA (US); NATHANIEL ANTER CANERA, LOS ANGELES, CA (US)

(21) Appl. No.: 19/210,833

(22) Filed: May 16, 2025

Related U.S. Application Data
(60) Provisional application No. 63/648,766, filed on May 17, 2024.

(51) Int. Cl. G06T 7/68; G01N 21/87; G06T 7/00

(52) U.S. Cl. CPC G06T 7/68; G01N 21/87; G06T 7/0002; G01N 2201/126; G06T 2207/20081; G06T 2207/20084

(57) ABSTRACT

According to one embodiment, there is presented herein a method of automatically evaluating the optical symmetry of a loose diamond. In more particular, the instant invention utilizes an AI system that has been trained using a curated database of optically graded diamond images to recognize degrees of optical symmetry. Images of other diamonds can then be presented to the trained AI system in order to obtain an estimate of an optical symmetry grade of the pictured diamond.

### CROSS REFERENCE TO RELATED APPLICATIONS

This application claims the benefit of U.S. Provisional Patent Application Ser. No. 63/648,766 filed on May 17, 2024, and incorporates said provisional application by reference into this document as if fully set out at this point.

### TECHNICAL FIELD

The instant invention relates generally to methods of evaluating gemstones and, more particularly, automated systems and methods of evaluating the optical symmetry of a loose diamond.

### BACKGROUND

The major characteristics that are used to evaluate diamond quality are generally referred to the “Four Cs”, i.e., carat, color, clarity and cut. The grading of carat, color and clarity are straightforward and have become standardized in the industry by the major gemological laboratories. Cut however is a much more nuanced characteristic. Cut quality directly correlates with a diamond's level of brilliance and its perceived beauty.

There are distinct physical properties of a gemstone that are typically considered when cut quality is to be determined. Some of these properties are:
Proportions. Diamonds with favorable proportions such as specific angles of facets and their percentages results in a diamond with a superior balance of brilliance, fire and scintillation. Gemological laboratories factor proportions when determining cut quality.
Physical Symmetry. The degree of the symmetric alignment of the physical facets of a diamond. Physical symmetry is an important factor that is rated by all gemological laboratories. The Gemological Institute of America rates physical symmetry under their “Symmetry” grade.
Optical Symmetry. Optical symmetry is the degree of alignment of multiple facets in tandem of a diamond in 3D space. A diamond with a superior level of optical symmetry will exhibit a structured and symmetric facet pattern in the “face up” position. A round diamond having a very high level of optical symmetry displays a clear and distinct eight arrow facet pattern. With emerald cut and square emerald cut diamonds, a balanced hall of mirrors effect is shown. With other shapes such as ovals and radiant cuts, a symmetric facet pattern is visible. Optical symmetry is a major factor in the cut quality of a diamond and its perceived beauty. Currently no known major gemological laboratory grades optical symmetry.

A growing portion of diamond purchases occurs online. Consumers considering an online purchase are typically presented with a limited amount of information about the subject diamond. That information might include a lab report and/or media such as photos or videos of the diamond. The major laboratories that provide lab reports typically assigning a cut grade without factoring optical symmetry. As an example, the world's foremost authority in diamond verification, GIA, grades diamonds based on proportions, physical symmetry, and polish attributes. The crucial attribute of cut quality, optical symmetry, is omitted and not graded.

In an attempt to bridge this information gap, some diamonds are accompanied by analytic information such as “hearts and arrows scope” imagery which helps to determine optical symmetry. A hearts and arrows scope is a hardware tool used to analyze optical symmetry. A diamond placed inside this tool allows the viewer to easily judge a diamond's 3D symmetry. The vast majority of diamonds offered online, approaching by some estimates up to ninety nice percent, do not come accompanied with any hearts and arrows scope or other analytic imagery. The imagery offered are of a bare loose diamond. The difficulty for the consumer is assessing optical symmetry from imagery of a bare loose diamond without the aid of an analytic scope (FIG. 1A) which produces images of the sort illustrated in FIG. 1B and FIG. 1C.

Typically, “experienced eyes”, such as those found in a diamond professional or gemologist, are required to grade optical symmetry. This general determination can be made by examining a diamond in the “faceup” position by physically examining it with a magnifying loupe but can also be judged with “face up” imagery of a diamond found online. The focus of this application is on online media. A consumer, who in most instances, is purchasing a diamond for the first time online does not have the expertise to judge 3D symmetry from the face up imagery of a diamond.

Existing tools in the marketplace which grade cut quality are hardware based and necessitate the physical presence of a diamond which is then scanned by these tools and graded.

Thus, what is needed is a system and method for an imaged-based software method of determining the optical symmetry of a gemstone that does not suffer from the disadvantages of the prior art.

Before proceeding to a description of the present invention, however, it should be noted and remembered that the description of the invention which follows, together with the accompanying drawings, should not be construed as limiting the invention to the examples for embodiments) shown and described. This is so because those skilled in the art to which the invention pertains will be able to devise other forms of this invention within the ambit of the appended claims.

### SUMMARY OF THE INVENTION

The methods taught herein provide an automated method for assessing the “3D symmetry” quality of hearts-and-arrows cut diamonds from images using machine learning. According to one embodiment, there is presented herein a software-based method of automatically evaluating the optical symmetry of a loose diamond. In more particular, the instant invention utilizes an AI system that has been trained using a curated database of digital images of pre-graded diamonds to recognize degrees of optical symmetry. Images of ungraded diamonds can then be presented to the trained AI system and an estimate of optical symmetry obtained therefrom.

According to one embodiment, a collection of preprocessed curated diamond images and associated optical symmetry data that has been assigned by an expert will be assembled and stored in a curated database. The data will then be provided to an AI program which might be a Convolutional Neural Networks (“CNN”) for purposes of training. As a component of the training step, it is expected that a validation step might be useful. Of course, that may or may not be necessary and those of ordinary skill in the art will readily be able to determine whether that step would be beneficial.

Once it has been trained, the convolutional neural network will be configured to allow users to submit faceup unevaluated diamond images to the trained AI/CNN. The AI/CNN, based on its prior machine learning, will analyze the faceup images, extract the facet patterns from these images and assign an optical symmetry grade based on its trained algorithm.

In one approach, the optical symmetry grade will be based on the symmetric reflections of the facets of a diamond as shown in a digital image. These reflections can range from areas of contrast (black) to brightness (white) areas visible in a diamond's image.

In a round brilliant diamond, the invention will prioritize the appearance of a symmetric eight arrow facet pattern visible as contrast (dark gray to black) in the face up image of the diamond. In other shapes, the invention will search for the symmetric appearance of the facets with areas of brightness and contrast without the eight arrow facet pattern visible in a round.

In an oval shape, beside judging the symmetric facet pattern in this shape, the invention will search for the “bow-tie” effect in the stone, which is visible as a noticeable, contrasting (dark gray to black) bow-tie emanating from the culet of the diamond.

In the emerald cut and square emerald shapes, the invention will search for and identify diamonds with too much contrast which are overly dark under the center which is indicative of too much obstruction or contrast in the diamond. The dark areas in these shapes are due to unfavorable proportions in a diamond which causes it to reflect shadow back to the viewer and may or may not indicate poor optical symmetry. The algorithm will prioritize a balance of contrast and brightness in automatically assessing symmetry which may or may not indicate too much darkness or “obstruction” in a diamond.

The foregoing has outlined in broad terms some of the more important features of the invention disclosed herein so that the detailed description that follows may be more clearly understood, and so that the contribution of the instant inventors to the art may be better appreciated. The instant invention is not to be limited in its application to the details of the construction and to the arrangements of the components set forth in the following description or illustrated in the drawings. Rather, the invention is capable of other embodiments and of being practiced and carried out in various other ways not specifically enumerated herein. Finally, it should be understood that the phraseology and terminology employed herein are for the purpose of description and should not be regarded as limiting, unless the specification specifically so limits the invention.

### BRIEF DESCRIPTION OF THE DRAWINGS

These and further aspects of the invention are described in detail in the following examples and accompanying drawings.

FIG. 1: A hearts and arrows scope (FIG. 1A) and resulting scope images (FIGS. 1B and 1C).

FIG. 2: Face up images of round diamonds with poor (FIG. 2A), mediocre (FIG. 2B) and excellent (FIG. 2C) optical symmetries.

FIG. 3: Faceup image of a round diamond (FIG. 3A) with extracted eight arrow pattern (FIG. 3B) and eight-star pattern (FIG. 3C).

FIG. 4: FIGS. 4A, 4C, and 4E show faceup images of round diamonds with increasing amounts of optical symmetry left to right. FIGS. 4B, 4D, and 4F show the images of the diamonds of FIGS. 4A, 4C, and 4E, respectively, with increased contrast with the extracted facet patterns in black for increased ease in viewing the optical symmetry.

FIG. 5: An operating logic suitable for use with an embodiment.

FIG. 6: Emerald cut diamond optical symmetry examples having too much darkness (FIG. 6A), too much brightness (FIG. 6C) and the right amount of brightness and darkness (FIG. 6B).

FIG. 7: This figure contains a round diamond optical symmetry example with areas of brightness and darkness highlighted.

FIG. 8: two oval diamond examples with (FIG. 8A) and without (FIG. 8B) the bow-tie effect.

FIG. 9 contains an operating logic that provides additional details regarding steps 510 and 520.

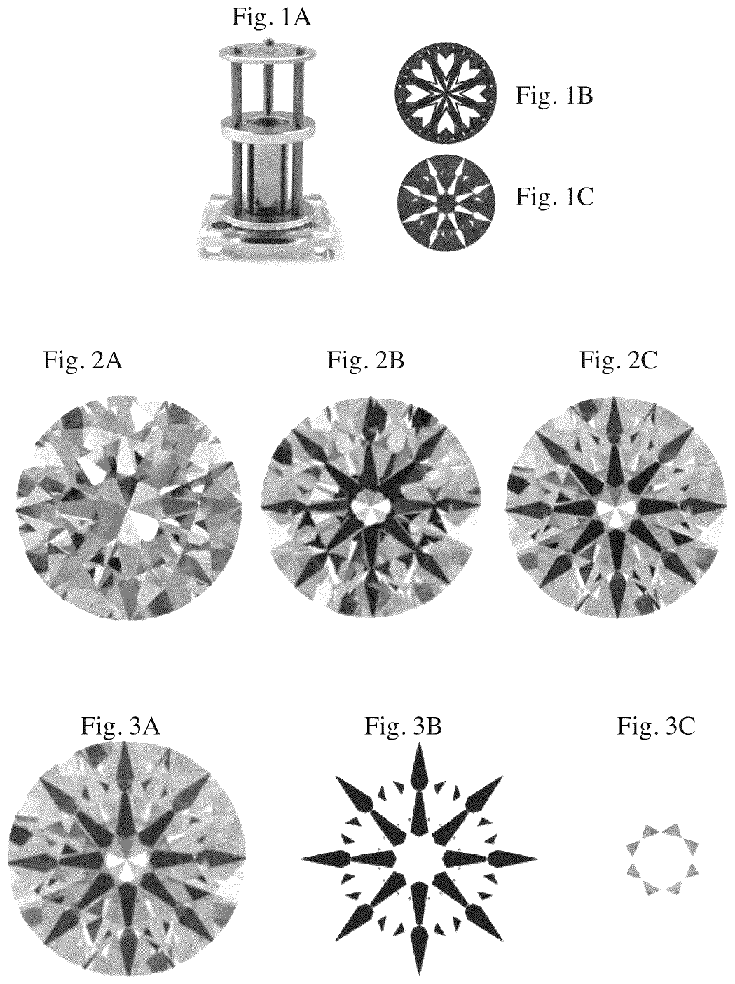

The invention will be described in connection with its preferred embodiments. However, to the extent that the following detailed description is specific to a particular embodiment or a particular use of the invention, this is intended to be illustrative only and is not construed as limiting the invention's scope. On the contrary, it is intended to cover all alternatives, modifications, and equivalents included within the invention's spirit and scope, as defined by the appended claims.

### DETAILED DESCRIPTION

While this invention is susceptible of embodiment in many different forms, there is shown in the drawings, and will be described hereinafter in detail, some specific embodiments of the instant invention. It should be understood, however, that the present disclosure is to be considered an exemplification of the principles of the invention and is not intended to limit the invention to the specific embodiments or algorithms so described.

Currently, determining optical symmetry necessitates a diamond professional viewing a diamond in the face up position. An expert looks for a symmetric and structured facet pattern. The symmetric facet patterns of diamonds can also be gleaned from professional “face up” digital imagery or videos of loose diamonds prevalent on the internet today. In the prior art a diamond professional is required to manually search for and rate the existence of known patterns in the various diamond shapes.

However, artificial intelligence and machine learning have created new opportunities in the marketplace. Convolutional Neural Networks or CNNs for short are a type of algorithm or machine learning that utilizes three-dimensional data for image classification. CNN's are old and well known in the art. The ability of a CNN to use 2D and/or 3D data as input makes it suitable for use in the classification 3D diamond symmetry.

FIG. 2 contains some example diamond images that illustrate different levels of optical symmetry. Note that the images that are used according to methods taught herein might take the form a JPEG, GIF, TIFF file, or any other suitable image file format. The right most diamond image (FIG. 2C) has the highest degree of optical symmetry and the one on the left (FIG. 2A) has the least. The middle one has a degree of optical symmetry that is between the other two. As can be seen, the facet pattern becomes much more apparent on the right most diamond (FIG. 2C) and is less clear in the middle (FIG. 2B) diamond image.

Turning next to FIG. 3, in round diamonds (FIG. 3A) optical symmetry is indicated by the presence of the eight arrow facet pattern in the image (FIG. 3B) along with the eight star pattern which is present but less visible in the center of the diamond (extracted to improve visibility in FIG. 3C).

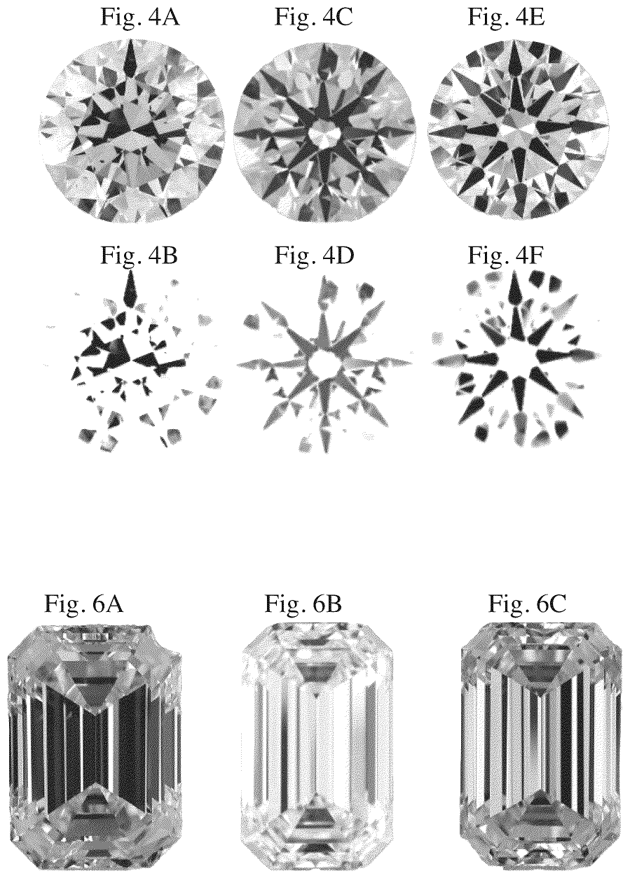

The visibility of these symmetry-related patterns can typically be improved in diamond images by increasing the contrast of the image as has been done in FIG. 4. FIGS. 4A, 4C, and 4E contain faceup images of round diamonds with increasing amounts of optical symmetry left to right. Below each round diamond is an enhanced contrast image (FIGS. 4B, 4D, and 4F). As can be seen, with increased contrast the facet patterns (or lack of same) are easier to identify by visually and, similarly, automatically by the computer-based methods disclosed herein.

In emerald cut and square emerald cut diamonds, this can be the balance between dark and white areas in a diamond which denotes a diamond having a good balance of the “hall of mirrors effect”. That is, and as is illustrated generally in FIG. 6, this figure contains images of an emerald cut diamond that has excessive dark regions (FIG. 6A), one that has excessive light regions (FIG. 6B) and one that has a good balance of light and dark regions (FIG. 6C). The emerald cut diamond of FIG. 6C is one that would be an example of stone with good optical symmetry. This is one aspect of that the instant method uses to determine optical symmetry, i.e., the balance between brightness and darkness in an emerald cut diamond.

FIG. 7 contains another illustration of a diamond. FIG. 7 was chosen to illustrate how different areas of brightness 710 and darkness 720 may found in a diamond image. This contrast between white and black, which can be similar in some ways to a checkerboard pattern, is what makes the facet pattern of a diamond visible to the unaided eye. Without a sufficiently high level of contrast and a visible facet pattern, a diamond would look something like the one contained in the image of FIG. 4A. The eight arrow facet pattern is very distinguishable in the diamond of FIG. 4C and it has high contrast which is the amount of white to black in the image.

In oval cut, radiant cut, pear shape, cushion cut, heart shape and princess cut diamonds, one aspect of the instant method would search for symmetry in the facet patterns in the faceup position while watching for the “bow-tie effect” in ovals, radiants, and pear shapes. As is schematically illustrated in FIG. 8, the left diamond (FIG. 8A) has a visible bow-tie effect whereas the right diamond (FIG. 8B) does not. The so-called bow-tie is formed by the two dark triangular shapes emanating from the center of the stone in FIG. 8A. When the two dark triangular shapes are considered together they form the basic shape of a bow-tie of the sort which might be worn with a tuxedo or other formal (or informal) wear. The right diamond (FIG. 8B) has no visible dark area and no visible bow-tie effect. As such, the right diamond would be classified as having less optical symmetry than the one the left. Note that some ovals exhibit this pattern and others do not.

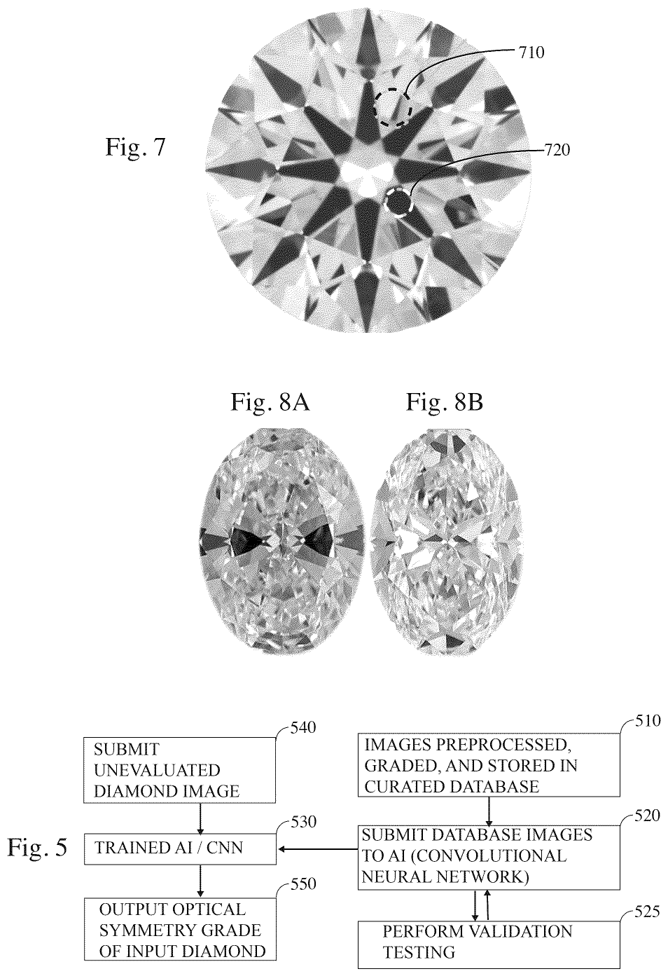

Turning now to FIG. 5, a high level overview of an embodiment operates as follows:
1—Data images will be assembled. In a preferred arrangement the input data to an embodiment will comprise images of individual loose diamonds in their face up positions.
2—Optical symmetry grades of the assembled images will be assigned to each image by a diamond professional and the images and their grades will preferably be stored together in a curated image database (step 510).
3—The curated database will be submitted to a customized AI/CNN routine (step 520), for training. This routine will preferably utilize CNN “hyperparameters” to learn how to recognize and grade diamond images.
4—Validation testing (step 525) will be performed using the AI/CNN to test the accuracy of the method with the current parameters and determine optimal hyperparameters.
5—Steps 3 and 4 may be repeated if more accuracy is required to produce a trained AI/CNN (step 530).
6—The trained AI/CNN will be given images of loose diamonds in their face up position (step 540) and the AI/CNN will assign an optical symmetry grade to each image (step 550).

With respect to creating the curated database (step 510), a diamond professional will examine images of bare loose diamonds in their faceup positions and associate a rating of the symmetric facet pattern of each diamond with that image. The professional will be searching the diamond images to see whether facet patterns of the sort identified previously can be identified. Then, that information would be used as a means of assigning a grade based on the diamond's level of symmetry. The grades could consist of text categories (e.g., poor, good, better, best) or be numerical in nature. As one example of a possible numerical rating system, assuming a scale that varies between 1 (a poor symmetry score) to 10 (excellent symmetry), images 4A, 4B, and 4C might be assigned scores of 2, 5 and 9, respectively. Of course, this is only provided as an example and should not be used to limit the invention nor the scope of the claims that follow.

The grades and associated images will be entered into a curated database which will be compromised of an image of a loose diamond (or a link to an image) and its corresponding grade. Thousands of data pairs of images and grades may be required to train the CNN to an acceptable level of accuracy.

With respect to step 520, the convolutional neural network CNN (or AI/CNN) will preferably be created/customized and optimized for the purpose of this application using “hyperparameters”. Hyperparameters are, in simplest terms, settings which are selected prior to teaching a neural network to do a task. Validation testing will then be required to gauge AI accuracy. Hyperparameters optimization will preferably occur to increase the accuracy of the CNN model.

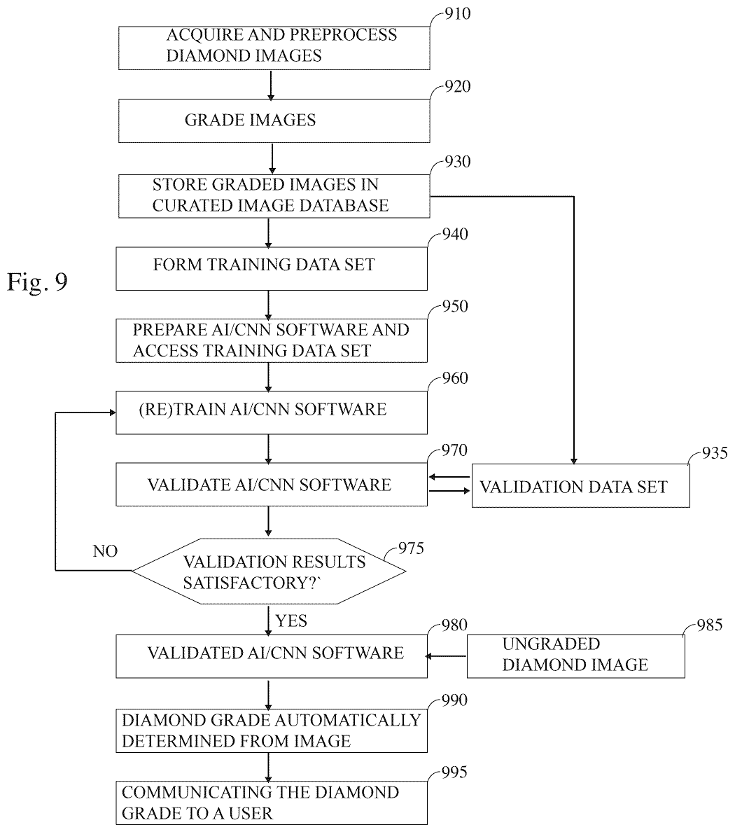

Turning next to FIG. 9, this figure contains additional information regarding steps 510-525. As a preliminary step 910, the images that are intended to be made part of the curated image database 510 will be assembled and preprocessed. As has been described previously, these images will be top-down views of diamonds. In some embodiments, conventionally lighted diamond images (e.g., by fluorescent, incandescent, or LED lighting) will be used, although that is not a requirement. Those of ordinary skill in the art will be able to determine if specialized lighting might prove to be more useful (e.g., color lighting, specific bandwidth ranges, etc.). Preferably, the images will be initially captured manually although that is not a requirement.

According to one embodiment, each image will preferably be preprocessed by subjecting it to gamma and contrast enhancement to more clearly define the edges of the reflective facets that are in the image. Additionally, it is preferred that this will be followed by application of the Hough Circle Transform algorithm to facilitate automatic identification of the stone's center and boundaries. Then, the images will preferably be modified to be uniform in size by, e.g., cropping, resizing, and systematically rotating them at multiple angles to augment the training dataset and mitigate overfitting. In some embodiments, the previous steps will produce standardized 224×224-pixel images suitable that are suitable for the CNN training that follows.

The processed images stored in the database will then be examined and manually graded by a trained jeweler who will visually evaluate the clarity and definition of the clock-face pattern present on a diamond's face (step 920). Each image will be manually examined and assigned scores that, in some embodiments, range from 1 (a poor symmetry score) to 10 (excellent symmetry) as part of this step. That being said, this is just one example of a grading scheme and those of ordinary skill in the art will readily be able to devise others. The image and grading will preferably be stored together in the curated image (training) database (step 930) although other configurations are certainly possible. Training 940 and validation datasets 935 are systematically partitioned, and the validation dataset 935 set aside for subsequent use. Of course, those of ordinary skill in the art will recognize that the step of partitioning might occur before or as the validation dataset is built by, for example, assigning each diamond image after it has been evaluated to either the validation dataset or the training data set.

One preferred AI scheme would involve use of a convolutional neural network (CNN), specifically utilizing transfer learning on the ResNet-50 architecture. (step 950) The training procedure 960 uses the training dataset 940 together with a pretrained ResNet-50 model, fine-tuned to classify diamond images into discrete symmetry grades (1-10). Those of ordinary skill in the art will recognize that a ResNet-50 model is a deep convolutional neural network (CNN) architecture developed as part of the broader Residual Network (ResNet) family. The “50” indicates the model's depth-50 layers. This model is often selected for use in image classification and computer vision tasks due to its ability to train very deep networks effectively.

During training step 960, the model undergoes hyperparameter tuning including adjustments in learning rate, epochs, batch size, and data augmentation in order to maximize accuracy and robustness. The output from this step will then be an initially trained version of the AI/CNN software module, where it should be understood and remembered that the AI/CNN model may be updated/modified multiple times at the next step.

The next preferred step is to validate 970 the initially trained model 960 by testing it against the validation data set 935. Note that the validation step 970 might include a parameter that controls how close the validation optical symmetry and the professionally determined optical symmetry need to be to be counted as successful, e.g., an error threshold. For example, if the error threshold parameter is chosen to be “0” the calculated validation value for an image will need to be exactly the same as the professionally determined value for that same image in order to be considered a validation success. On the other hand, if the parameter is set to “1” a validation value of “8” will be deemed a success if the true/professional valuation of that same image is “9” or “7”. If the trained AI produces a percentage of correctly identified images that is less a predetermined value, the trained AI model may be modified according to methods well known to those of ordinary skill in the art in order to improve its accuracy.

If the validation step reveals that the trained AI is not as accurate as was desired (the “NO” branch of decision item), the training process may be repeated as many times as necessary to obtain a satisfactory trained AI/CNN model 980. If the percentage of correctly identified images is greater than said predetermined value (the “YES” branch of decision item 975), the method will continue to the next step 980. In practice, the predetermined threshold value will typically be 95% or higher, although there may be instances where it is determined that a lower (or higher) percentage would be required. Those of ordinary skill in the art will recognize how this parameter might be chosen. More generally, the number of correct and/or incorrect optical symmetry estimates that are obtained during the validation step will be used to obtain a validation score that is compared with the predetermined threshold value to determine whether additional training is necessary.

The trained AI/CNN model 980 may then be presented with an ungraded diamond image 985 which will then provide as output an automatically determined diamond grade 990. The grade of the diamond might be presented to a user 995 as a number representative of the calculated grade of the diamond or a report that characterizes the symmetry of the subject diamond. Either way the grade or report will be presented to the user on a user readable device such as computer screen (to include mobile screens such as those used by tablet computers and smart phones) or printed on a material such a paper according to methods well known in the art.

The trained model provides rapid, objective, and consistent diamond symmetry grading with performance continuously monitored through validation accuracy and loss metrics. This invention thus is designed to eliminate human bias, reduce time and cost associated with traditional manual grading, and provide a scalable, reproducible method of diamond grading suitable for commercial deployment and widespread adoption in the gemological industry.

By way of summary, the invention provides an automated method for assessing the “3D symmetry” quality of hearts-and-arrows cut diamonds from images using machine learning. Conventionally, grading the 3D symmetry of a diamond-which significantly affects its brilliance and visual appeal-is done manually by trained jewelers who visually evaluate the clarity and definition of the clock-face pattern present on a diamond's face. This invention employs a convolutional neural network (CNN), specifically utilizing transfer learning on the ResNet-50 architecture, to automate this subjective grading process. The methodology involves a carefully structured data acquisition and preprocessing pipeline, where raw images are initially captured by hand, manually evaluated by a professional and assigned a symmetry score. Each raw image undergoes gamma and contrast enhancement to clearly define diamond edges, facilitating automatic identification of the stone's center and boundaries via the Hough Circle Transform algorithm. The images are then uniformly cropped, resized, and systematically rotated at multiple angles to augment the training dataset and mitigate overfitting, producing a standardized dataset of 224×224-pixel images suitable for CNN training.

The training procedure leverages transfer learning techniques using a pretrained ResNet-50 model, fine-tuned to classify diamond images into discrete symmetry grades (1-10). Training and validation datasets are systematically partitioned, and the model undergoes hyperparameter tuning—specifically, adjustments in learning rate, epochs, batch size, and data augmentation—to maximize accuracy and robustness. The trained model provides rapid, objective, and consistent diamond symmetry grading with performance continuously monitored through validation accuracy and loss metrics. This invention thus eliminates human bias, reduces time and cost associated with traditional manual grading, and provides a scalable, reproducible method suitable for commercial deployment and widespread adoption in the gemological industry.

It should be noted and understood that the invention is described herein with a certain degree of particularity. However, the invention is not limited to the embodiment(s) set for herein for purposes of exemplifications, but is limited only by the scope of the attached claims.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

The singular will include the plural and vice versa unless the context in which the term appears indicates otherwise.

If the specification or claims refer to “an additional” element, that does not preclude there being more than one of the additional element.

It is to be understood that where the claims or specification refer to “a” or “an” element, such reference is not to be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

For purposes of the instant disclosure, the term “at least” followed by a number is used herein to denote the start of a range beginning with that number (which may be a ranger having an upper limit or no upper limit, depending on the variable being defined). For example, “at least” means or more than. The term “at most” followed by a number is used herein to denote the end of a range ending with that number (which may be a range having or 0 as its lower limit, or a range having no lower limit, depending upon the variable being defined). For example, “at most 4” means 4 or less than 4, and “at most 40%” means 40% or less than 40%.

Terms of approximation (e.g., “about”, “substantially”, “approximately”, etc.) should be interpreted according to their ordinary and customary meanings as used in the associated art unless indicated otherwise. Absent a specific definition and absent ordinary and customary usage in the associated art, such terms should be interpreted to be #0% of the base value.

When, in this document, a range is given as “(a first number) to (a second number)” or “(a first number)-(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 4-45, 28-96, etc. Note that integer range values have been used in this paragraph for purposes of illustration only and decimal and fractional values (e.g., 46.7-94.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

Still further, additional aspects of the instant invention may be found in one or more appendices attached hereto and/or filed herewith, the disclosures of which are incorporated herein by reference as if fully set out at this point.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A method of automatically obtaining an AI generated optical symmetry grade of an ungraded subject diamond using a subject diamond image thereof, comprising the steps of:
(a) submitting a plurality of ungraded diamond images to a diamond professional to evaluate, said evaluation comprising assigning an optical symmetry grade to each of said ungraded diamond images, thereby producing a plurality of graded diamond images;
(b) associating each of said plurality of graded diamond images with either a training database or a validation data set, said training database having a first plurality of said graded diamond images associated therewith and said validation data set having a second plurality of said graded diamond images associated therewith;
(c) using said first plurality of graded diamond images associated with said training database to train an AI computer program to assign an optical symmetry grade to a diamond image, thereby producing a trained AI computer program;
(d) using said trained AI computer program to assign a validation optical symmetry grade to each of a third plurality of said graded diamond images associated with said validation data set;
(e) for each of said third plurality of graded diamond images, comparing said validation optical symmetry grade to said professional optical symmetry grade to determine a number of validation optical symmetry grades that are within an error threshold of said professional optical symmetry grade;
(f) if a number of validation optical symmetry grades that are within said error threshold of said professional optical symmetry grade is greater than or equal to a predetermined value,
(1) submitting said subject diamond image to said trained AI computer program, thereby obtaining said AI generated optical symmetry grade of said subject diamond image, and
(2) communicating said AI generated optical symmetry grade of said subject diamond to a user by way of a user readable device;
(g) if said number of validation optical symmetry grades that are within said error threshold of said professional optical symmetry grade is less than said predetermined value,
(1) continuing to perform at least steps (c) through (e) until said number of validation optical symmetry grades that are within said error threshold of said professional optical symmetry grade is greater than or equal to said predetermined value, thereby producing a retrained trained AI computer program,
(2) submitting said subject diamond image to said retrained trained AI computer program, thereby obtaining said AI generated u optical symmetry grade of said subject diamond image, and
(3) communicating said AI generated optical symmetry grade of said subject diamond to a user by way of a user readable device.

2. The method according to claim 1, wherein said AI program comprises a convolutional neural network.

3. The method according to claim 2, wherein said AI program comprises a convolutional neural network that uses hyperparameter optimization.

4. The method according to claim 1 wherein said AI program utilizes a convolutional neural network.

5. The method according to claim 4 wherein said AI program convolutional neural network utilizes a ResNet-50 architecture.

6. The method according to claim 1, wherein said predetermined value is 95% of a number of said third plurality of graded diamond images.

7. The method according to claim 1, wherein said error threshold is either zero or one.

8. A method of automatically generating an optical symmetry grade of a subject diamond using an image of said subject diamond, wherein is provided:
a training database, wherein said training database comprises a first plurality of professionally graded diamond images, each of said first plurality of professionally graded diamond images having a training optical symmetry grade associated therewith, and
a validation data set, wherein said validation data set comprises a second plurality of professionally graded diamond images, each of said second plurality of graded diamond images having said a professional optical symmetry grade associated therewith,
comprising the steps in a computer of:
(a) using said first plurality of training graded diamond images in said training database and said training optical symmetry grades associated therewith to train said AI computer program to grade an optical symmetry of an ungraded diamond image, thereby obtaining a trained AI computer program;
(b) using said trained AI computer program to obtain a validation optical symmetry value for each of said second plurality of professionally graded diamond images in said validation data set;
(c) comparing said validation optical symmetry value for each of said second plurality of professional graded diamond images in said validation data set with said professional optical symmetry grade associated therewith to obtain a validation score for said trained AI computer program;
(d) if said validation score is greater than or equal to a predetermined value,
(1) submitting said subject diamond image to said trained AI computer program, thereby obtaining said AI generated optical symmetry grade of said subject diamond image, and
(2) communicating said AI generated optical symmetry grade of said subject diamond to a user by way of a user readable device;
(g) if said validation score is less than said predetermined value,
(1) continuing to perform at least steps (b) and (c) to retrain said trained AI computer program until said validation score is greater than or equal to said predetermined value,
(2) submitting said image of said subject diamond to said retrained trained AI computer program, thereby obtaining said AI generated optical symmetry grade of said subject diamond image, and
(3) communicating said AI generated optical symmetry grade of said subject diamond to a user by way of a user readable device.

9. The method according to claim 8, wherein said predetermined value is 95% and said validation score is a percentage of said validation optical symmetry values that are equal to said corresponding validation optical symmetry grade.

10. The method according to claim 8, wherein said predetermined value is greater than 95%.

11. The method according to claim 8, wherein said AI program is a convolutional neural network that uses hyperparameter optimization.

12. The method according to claim 8 wherein said AI program utilizes a convolutional neural network.

13. The method according to claim 8 wherein said AI program convolutional neural network utilizes a ResNet-50 architecture.
